(19) United States
(12) Patent Application Publication
(10) Pub. No.: US 2020/0139306 A1
(43) Pub. Date: May 7, 2020

(54) Systems And Methods For Liquid Purification

(71) Applicant: The Regents of the University of California, Oakland, CA (US)

(72) Inventors: Zuzanna Siwy, Irvine, CA (US); Yinghua Qiu, Irvine, CA (US); Crystal Yang, Irvine, CA (US); James Boyd, Riverside, CA (US)

(21) Appl. No.: 16/615,934

(22) PCT Filed: May 22, 2018
(86) PCT No.: PCT/US2018/033832

§ 371 Date: Nov. 22, 2019

Related U.S. Application Data
(60) Provisional application No. 62/509,345, filed on May 22, 2017.

(51) Int. Cl. B01D 69/02; B01D 71/64; B01D 71/48; C02F 1/44

(52) U.S. Cl. CPC B01D 69/02; B01D 71/64; B01D 71/48; C02F 1/442; C02F 2103/08; B01D 2325/16; B01D 2325/26; B01D 2325/021; B01D 2325/20; B01D 2325/14

(57) ABSTRACT

A membrane includes a plurality of nanopores, each nanopore including a first opening on a first side of the membrane, a second opening on a second side of the membrane, and an inner surface that extends between the first and second openings, wherein at least one nanopore comprises a positive surface charge zone extending along a portion of a length of the nanopore and a negative surface charge zone extending along a different portion of the length of the nanopore, wherein the inner surface of the nanopore has high-density positive surface charges within the positive surface charge zone and high-density negative surface charges within the negative surface charge zone.

### CROSS-REFERENCE TO RELATED APPLICATION

This application claims priority to co-pending U.S. Provisional Application Ser. No. 62/509,345, filed May 22, 2017, which is hereby incorporated by reference herein in its entirety.

### BACKGROUND

Liquid purification involves the removal of undesired components from the liquid. Water desalination is one form of liquid purification in which salts (e.g., anions and/or cations from species that ionize in water) are removed from the water to reduce the dissolved salt content of the water to a desired level.

While there are various known methods for desalinating water, such as reverse osmosis and electrodialysis, these methods are expensive and cost prohibitive for applications on a large or global scale. One major expense associated with the use of these methods is the energy required to pressurize the feed water. For brackish water desalination, the operating pressures range from 250 to 400 psi. For seawater desalination, the operating pressures range from 800 to 1,000 psi. Reverse osmosis and electrodialysis are also relatively low-flux processes and, therefore, produce desalinated water at relatively slow rates. As such, they are not suitable for high-volume desalination, which may be necessary for large-scale applications, such as desalinating water for agricultural purposes.

In view of the above facts, it can be appreciated that it would be desirable to have alternative systems and methods for liquid purification, including water desalination.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a schematic view of an embodiment of a liquid purification system.

FIG. 2 is a schematic view of an embodiment of a liquid purification membrane of the system of FIG. 1.

FIG. 3 is a schematic view of a nanopore of the liquid purification membrane of FIG. 2.

FIGS. 4(a) and 4(b) are graphs that plot the results of modeling salt rejection for a cylindrical nanopore for various surface charge densities. This nanopore had a zone with positive surface charge and a zone with negative surface charge; both zones had the same length.

FIG. 5 is a graph that plots the results of modeling salt rejection for a cylindrical nanopore for various concentrations of feed solution. This nanopore had a zone with positive surface charge and a zone with negative surface charge; both zones had the same length.

FIG. 6 is a graph that plots the results of modeling salt rejection for a cylindrical nanopore for various pressure differentials. This nanopore had a zone with positive surface charge and a zone with negative surface charge; both zones had the same length.

FIGS. 7(a)-7(d) are graphs that plot the results of modeling salt rejection for a conical nanopore having various opening diameters and surface charge zone lengths.

FIG. 8 is a graph that plots the results of modeling salt rejection for a conical nanopore for various concentrations of feed solution.

### DETAILED DESCRIPTION

As described above, it would be desirable to have alternative systems and methods for liquid purification, such as water desalination. Disclosed herein are embodiments of systems and methods for liquid purification that can be used in various applications, including water desalination. The systems comprise one or more porous membranes through which a liquid, such as water, can be passed. The membrane rejects undesired components, such as salts, contained in the liquid to reduce the concentration of the undesired components. In some embodiments, nanopores of the membrane comprise positively and negatively charged zones along their lengths that facilitate the rejection of the undesired components. In some embodiments, the nanopores are asymmetric along their lengths.

It is noted that the embodiments described herein are only illustrative and not intended in any way to restrict the disclosed inventions or the various aspects and features of these inventions. Furthermore, the phraseology and terminology used herein are used for the purpose of description and should not be regarded as limiting. No features, structures, or steps disclosed herein are essential or indispensable to the disclosed inventions.

As identified above, a liquid purification system according to this disclosure comprises one or more porous membranes that can be used to limit the passage of undesired components, such as salts (e.g., ions, charged molecules, etc.), impurities, or contaminants for purposes of removing the components from a liquid, such as water. In some embodiments, the membrane prevents the passage of certain molecules based on their charge. By rejecting these components, the liquid that passes through the membrane is purified (i.e., has a reduced concentration of the components). In some embodiments, the percentage of reduction of the undesired components by the membrane (or a set of membranes) is at least approximately 50%, 70%, 90%, 99%, or ranges including and/or spanning those values.

In some embodiments, the membrane is configured to reject alkali metal ions (e.g., ions of the Group I metals). In some embodiments, the membrane is configured to reject alkaline earth metal ions (e.g., ions of the Group II metals). In some embodiments, the membrane is configured to reject halide ions (e.g., F⁻, Cl⁻, Br, I⁻). In some embodiments, the membrane is configured to reject the anions of organic molecules (e.g., carboxylate containing organic molecules such as carboxylic acids, etc.). In some embodiments, the membrane is configured to reject the cations of organic molecules (e.g., ammonium salts of amines). In some embodiments, the membrane is configured to reject one or more ions selected from: K⁺, Na⁺, Li⁺, Cs⁺, Ca²⁺, Mg²⁺, CI⁻, Br, HPO₄²⁻, HSO₄⁻, succinate, and/or acetate. In some embodiments, the membrane is configured to remove one or more of NaCl, KCl, NaH₂PO₄, sodium succinate, sodium acetate, etc.

In some embodiments, the membrane rejects the undesired components at low pressure differentials. The pressure differential is a parameter quantified as the pressure difference between the liquid to be purified (i.e., the feed solution) and the purified liquid (i.e., the filtrate or permeate). In some embodiments, the membrane operates at a pressure differential no greater than approximately 200 psi, 100 psi, 60 psi, 40 psi, or ranges including and/or spanning these values.

In some embodiments, the membrane rejects the undesired components while achieving high flux through the membrane. In some embodiments, a flux of at least approximately 40 to 80 liters/m²hr, or ranges including and/or spanning these values can be achieved.

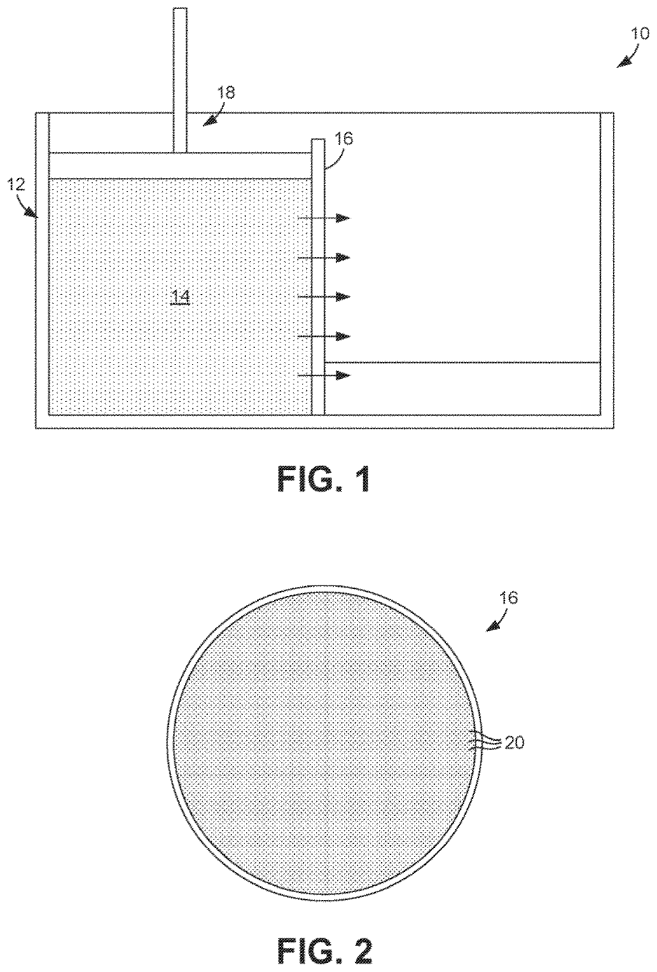

FIG. 1 illustrates an example embodiment of a liquid purification system 10. As shown in this figure, the system 10 comprises a reservoir 12 that contains a feed solution 14. In some embodiments, the feed solution 14 comprises water containing dissolved salts (e.g., brackish water, sea water, etc.). The system 10 also comprises a liquid purification membrane 16 through which the feed solution 14 can pass. The system 10 further comprises means for pressurizing and/or driving the feed solution 14, in the form of a piston 18 in the illustrated embodiment, to pressurize and drive the solution through the membrane 16. While a single membrane 16 is shown in FIG. 1, it is noted that multiple (e.g., 2, 3, 4, or more) membranes can be used, either in series (e.g., in a cascading arrangement), in parallel, or both.

FIG. 2 illustrates an example embodiment of the membrane 16 in plan view. As depicted in this figure, the membrane 16 comprises a plurality nano-scale pores, or nanopores 20, through which the feed solution 14 can pass. The membrane 16 can comprise a high density of nanopores 20 per unit area. By way of example, the membrane 16 can be provided with approximately 10⁷ to 10¹¹ nanopores per square centimeter.

In some embodiments, the membrane 16 can be made of one or more of an organic material and an inorganic material. In some embodiments, the membrane 16 comprises one or more organic polymeric materials, such as polyimide (e.g., Kapton), polyethylene terephthalate (PET), other polymers, or combinations thereof. In some embodiments, the membrane material comprises one or more inorganic materials, such as mica, silica, silicon nitride, or combinations thereof.

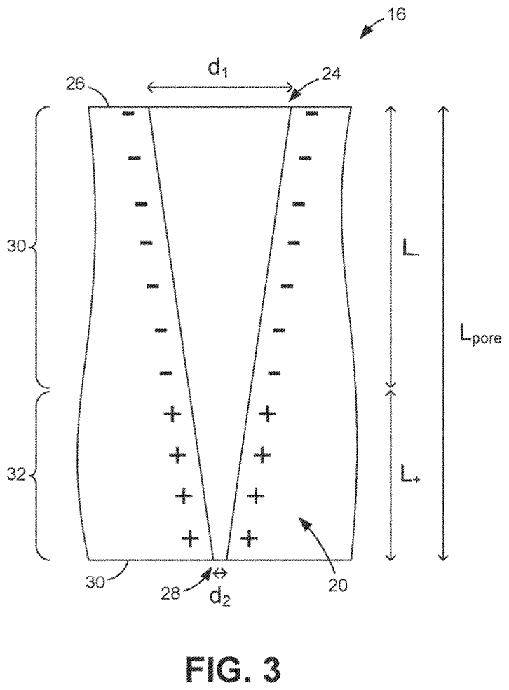

FIG. 3 is a partial cross-sectional view of the membrane 16 that shows an example configuration for a nanopore 20 of the membrane. As illustrated in this figure, the nanopore 20 extends from a first opening 24 at a first side 26 of the membrane 16 to a second opening 28 at a second side 30 of the membrane. By way of example, the length of the nanopore 20, Lₚₒᵣₑ, (which can also be the thickness of the membrane 16) can be approximately 500 nm to 10 μm (e.g., 500 nm, 1000 nm, 5 μm, or 10 μm). In some cases, the first opening 24 acts as an inlet opening through which the feed solution 14 enters the nanopore 20, and the second opening 28 acts as an outlet opening from which purified liquid exits the nanopore. In other cases, however, the second opening 28 can act as the inlet opening and the first opening 24 can act as the outlet opening. As such, the nanopore 20, and by extension the membrane 16, is non-directional. Regardless of their roles, the first opening 24 can have a cross-sectional dimension (e.g., diameter), d₁, of approximately 300 nm to 2,000 nm (e.g., approximately 300 nm, 500 nm, 1000 nm, 1500 nm, or 2000 nm) and the second opening 28 can have a cross-sectional dimension (e.g., diameter), d₂, of approximately 1 nm to 15 nm (e.g., approximately 1 nm, 5nm, 10 nm, or 15 nm). Notably, both of these dimensions are larger than the diameters of the pores of conventional desalination membranes. For example, reverse osmosis membranes typically have pores that are less than 1 nm in diameter.

As is also apparent from FIG. 3, the nanopore 20 is asymmetric along its length and, therefore, has a non-constant cross-section from one end to the other. In the example of FIG. 3, the nanopore 20 has a tapered configuration in which the cross-sectional area of the nanopore decreases along its length from the first opening 24 to the second opening 28. By way of example, the nanopore 20 can have a conical configuration in which a diameter of the nanopore is largest at a first opening 24 and smallest at the second opening 28. Furthermore, the nanopore 20 can have a linearly decreasing diameter between the first and second openings 24, 28. While specific aspects, such as a conical shape, circular cross-section, and a linearly decreasing dimension have been identified, it is noted that none of these aspects is critical. As such, other shapes, cross-sections, and dimensions can be used. Furthermore, a shape that is largest at one end and smallest at the other end is not required. For example, the nanopore 20 can, alternatively, have a shape in which the smallest cross-sectional dimension occurs between the ends of the nanopore, as in the case of an hourglass shape.

A configuration having a non-constant cross-section, as in the example of FIG. 3, enables the use of lower pressures while simultaneously increasing flux, as compared to conventional membranes having cylindrical pores. In particular, a cylindrical pore having a constant diameter equal in size to the smaller of the openings 24, 28 (which defines the effective diameter of the nanopore 20) provides much greater resistance to water flow than the tapered configuration shown in FIG. 3 because the larger cross-section beyond the smaller opening enables water to pass through the membrane 16 more easily.

As is depicted in FIG. 3, the nanopores 20 can also comprise different surface charges along its length. For example, in the embodiment shown in FIG. 3, there is a negatively charged zone 30 near the first opening 24 and a positively charged zone 32 near the second opening 28. Within the negatively charged zone 30, the inner surfaces of the nanopore 20 have negative surface charges (identified by “−”) and within the positively charged zone 32, the inner surfaces of the nanopore have positive surface charges (identified by “+”). When it has such a configuration, the membrane 16 can be considered to be a “bipolar” membrane, which comprises a cation exchange zone and an anion exchange zone. Each zone 30, 32 is a fraction of the full length, Lₚₒᵣₑ, of the nanopore 20. In some embodiments, the length, L₊, of the positively charged zone 32 (i.e., the zone nearest the smallest cross-sectional dimension) is approximately 10 nm to 100 μm and the length, of the negatively charged zone 30 comprises the remaining fraction of Lₚₒᵣₑ. Notably, the locations of the surface charge zones 30, 32 can be varied. For example, the lengths of the zones 30, 32 can be varied. In addition, the positions of the two zones can be reversed such that the negatively charged zone 30 is near the second opening 28 and the positively charged zone 32 is near the first opening 24. This is true regardless of which of the openings 26, 28 is the larger or the smaller of the two openings.

In some embodiments, the surface charges are high-density surface charges. The charge densities can be measured in e/nm², where e is the “elementary charge.” In some embodiments, the charge densities are at least approximately 0.2 e/nm², 0.6 e/nm², 1.0 e/nm², 2.0 e/nm², or ranges including and/or spanning the these values. The charge densities can also be measured in Coulombs per m² (C/m²). In some embodiments, the charge densities are at least approximately 0.03 C/m², 0.09 C/m², 0.15 C/m², 0.30 C/m², 0.4 C/m², or ranges including and/or spanning these values.

Irrespective of the particular parameters of the surface charge zones 30, 32, it is the surface charges that electrostatically reject the undesired components from the feed solution 14 so that purified liquid exits the membrane 16 having a reduced concentration of the undesired components. Surprisingly, it has been determined that one can achieve liquid purification, such as water desalination, for higher concentrations of the feed solution than that predicted by the linear Debye-Hueckel theory. Without being bound to a particular mechanism, it is believed that, because the nanopores 20 reject ions by electrostatic action, the nanopores can be larger than the pores of other membranes currently used in existing liquid purification systems. In some embodiments, the smallest cross-section of the nanopore 20 (the opening 24 in the example of FIG. 3) can be larger than the Debye length of the liquid, such as water containing K⁺, Cl⁻, Na⁺, Li⁺, Cs⁺, Br, Ca²⁺, Mg²⁺, HPO₄²⁻, succinate, and/or acetate ions. In some embodiments, the ratio of the smallest pore cross-sectional dimension (e.g., diameter) to the Debye length is approximately 1:1, 3:2, 2:1, 4:1, or ranges including and/or spanning these ratios. At the same time, the smallest cross-section of the nanopore 20 can still be larger than the pores of other membranes currently used in existing liquid purification systems, thereby reducing the pressures that are required for purification and enabling higher rates of throughput.

The nanopores 20 are ion selective. Specifically, to fulfill electroneutrality, the solution in the nanopore will primarily contain counterions, e.g., cations, with negative surface charges. The magnitude of the difference in the concentration of counterions and coions depends on the surface charge density of the nanopore walls, opening diameters, bulk electrolyte concentration, and the charges of the ions. When the full non-linear form of the Poisson-Nernst-Planck equations are used, it can be predicted that, in 0.1 M KCl or NaCl, nanopores having a 3 nm effective diameter and a surface charge density of 0.5 elementary charge per nm² will be filled with counterions (e.g. positive ions, like potassium in the zone with negative surface charges) in 99%. If a pressure difference is applied across the membrane 16, the electroneutrality requirement will enable liquid to pass so that the ionic concentration in the permeate will be significantly lower than in the feed solution. Such modeling also predicts that nanopores 20 with the surface charge pattern shown in FIG. 3 are much more effective in rejecting ions than membranes with homogeneously charged pore walls.

In some embodiments, the desalination efficiency of the membrane 16 for a 100 mM KCl solution is at least approximately 8%, 20%, 60%, 80%, 90%, or ranges including and/or spanning these values. As a specific example, 80% desalination of 100 mM KCl can be achieved using a membrane 16 comprising nanopores 20 having a constant diameter of 10 nm and a surface charge density of at least 0.4 C/m².

Because of the relatively large dimensions and the asymmetric geometry of the nanopores 20, the membrane 16 is capable of flux rates that are multiple orders of magnitude higher than those of reverse osmosis membranes. By way of example, flux rates of approximately 40 to 80 liters/m² hr are possible. Because of this, the membrane 16 is well suited for purifying large volumes of liquid, such as water. The larger dimensions and asymmetric geometry also enable the use of much lower pressure differentials. For instance, liquid can be purified using a pressure difference of only 40 to 100 psi for a feed solution having 100 mM KCl. Reverse osmosis desalination systems, on the other hand, typically require pressures of at least 250 psi. The lower pressure requirement translates into lower energy inputs and, therefore, lower costs.

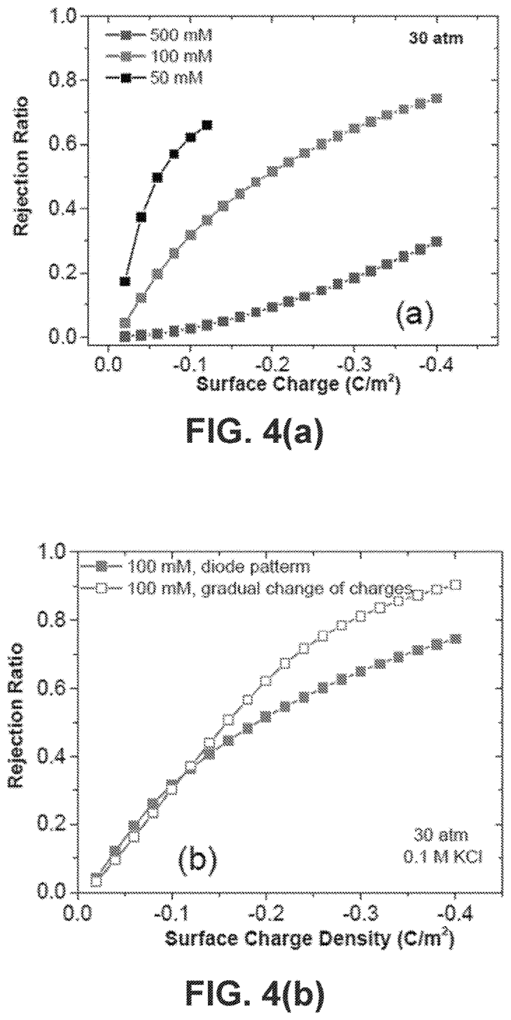

FIGS. 4-6 model how salt rejection with highly charged nanopores is possible in conditions in which the pore size is much greater than the Debye length. The numerical modeling was performed by numerically solving coupled Poisson-Nernst-Planck and Navier-Stokes equations using a Comsol Multiphysics package. The modeling focused on a range of salt concentrations that is of interest for desalination of brackish water.

FIGS. 4(a) and 4(b) are graphs that plot the results of numerical modeling of salt rejection with a cylindrically shaped nanopore having a diameter of 10 nm and a length of 1 μm. The nanopore contained a sharp junction between a 0.5 μm long positive surface charge zone and 0.5 μm long negative surface charge zone. As the surface charge density of both zones increased, the level of salt rejection also increased. As shown in FIG. 4(b), modeling was performed for a feed solution containing 100 mM KCl using two cases: (1) the case as in FIG. 4(a) (i.e., a sharp junction between the two zones) and (2) a case in which the surface charge density changes from +0.08 C/m² at one opening to −0.08 C/m² on the other opening in 10 equidistant steps.

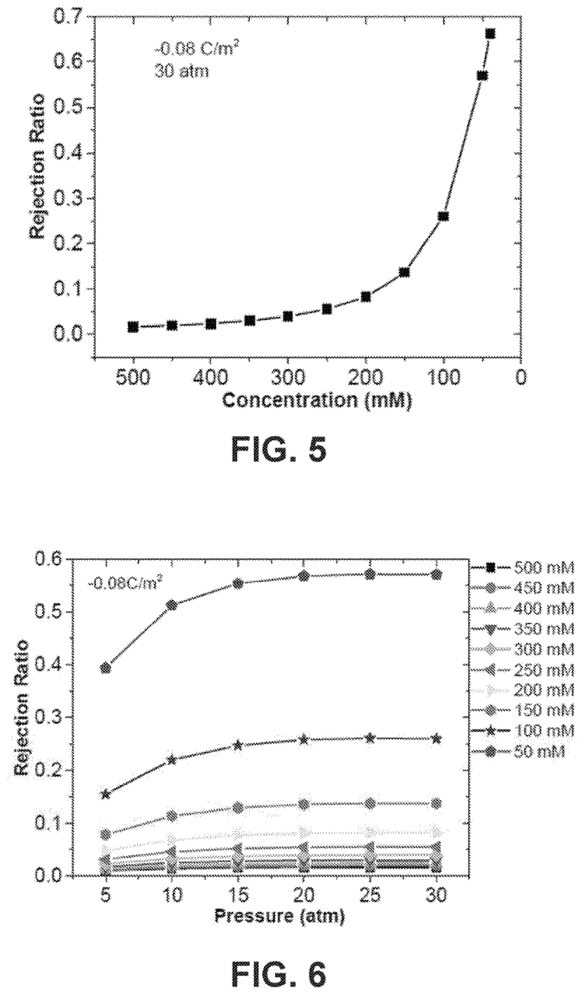

FIG. 5 is a graph that plots the results of numerical modeling of salt rejection by a cylindrical nanopore having a diameter of 10 nm and a length of 1 μm. The pore contained a sharp junction between a 0.5 μm long positive surface charge zone and a 0.5 μm long negative surface charge zone. The charge density was 0.08 C/m² (0.5 e/nm²). The salt rejection was more complete for lower KCl concentrations and reached 70% in 50 mM KCl. Notably, at 50 mM KCl, the classically predicted Debye length is approximately 1.3 nm, which is much smaller than the 10 nm diameter of the pore. Higher levels of salt rejection can be expected for higher densities of surface charges.

FIG. 6 is a graph that plots the results of numerical modeling of salt rejection by a cylindrical nanopore having a diameter of 10 nm and a length of 1 μm as function of transmembrane pressure difference. The pore contained a sharp junction between a 0.5 μm long positive surface charge zone and a 0.5 μm long negative surface charge zone. The charge density was 0.08 C/m² (0.5 e/nm²).

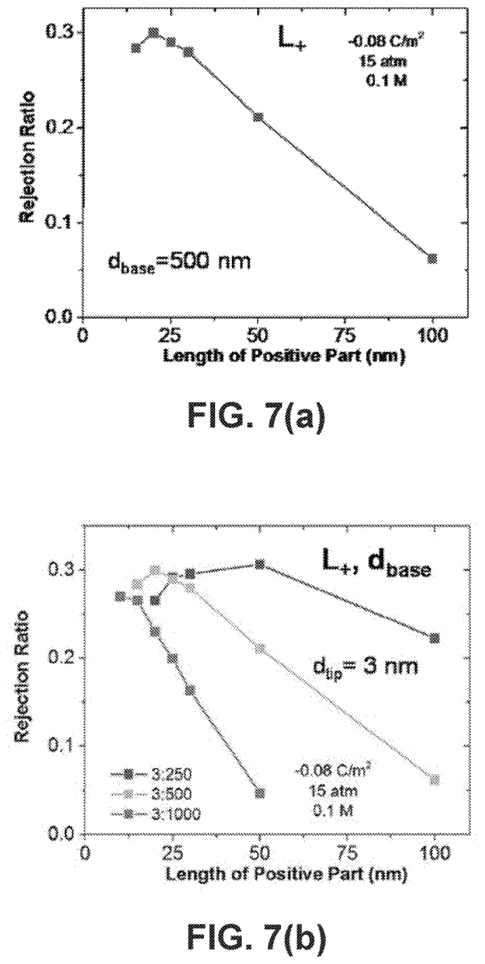

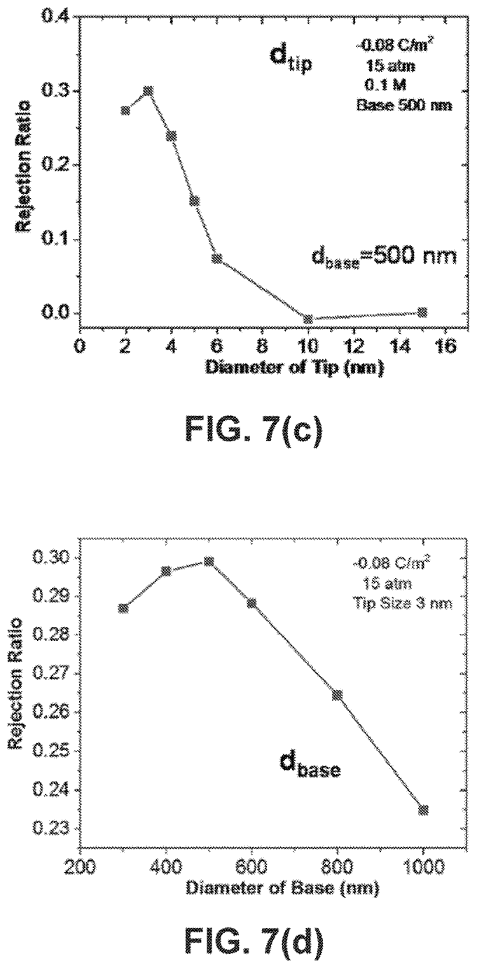

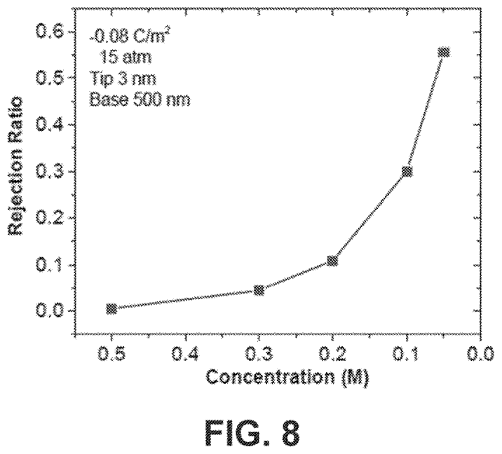

Numerical modeling was also performed for asymmetric nanopores. In particular, FIGS. 7 and 8 show predictions of salt rejection for conically shaped nanopores, such as that shown in FIG. 3, characterized with different opening diameters and surface charge zone lengths.

FIG. 7 includes multiple graphs that illustrate the effect of the dimensions of the nanopore on the rejection ratio. More particularly, FIGS. 7(a) and 7(b) take into account the length of the second surface charge zone 32 adjacent the second opening 28, FIG. 7(c) takes into account the diameter, d₂, of the second opening, and FIG. 7(d) takes into account the diameter, d₁, of the first opening 24. As can be appreciated from FIGS. 7(a) and 7(b), the length, L₊, of the surface charge zone 32 was varied from approximately 10 nm to approximately 100 nm. As can be appreciated from FIG. 7(c) the diameter, d₂, of the second opening 28 was varied from approximately 2 nm to approximately 15 nm. As can be appreciated from FIG. 7(d) the diameter, d₁, of the first opening 24 was varied from approximately 300 nm to approximately 1,000 nm. In each case, the positive and negative surface charge densities were 0.08 C/m².

The graphs of FIG. 7 reveal that the length, L₊, of the second charge zone 32 adjacent the second opening 28 and the size, d₂, of the second opening 28 effect separation. For a nanopore having a first opening 24 having a diameter, d₁, of 500 nm, the maximum salt rejection occurred with L₊=25 nm and d₂=3 nm. Notably, these dimensions are interrelated and what is the optimal dimension for any of L₊, d₂, and d₁ depends upon the other dimensions. For example, when d₂ is 3 nm, the optimal value of L₊ decreases with the increase of d₁. The diameter, d₁, of the first opening 24 is important as it, at least with a conical configuration such as that shown in FIG. 3, defines the rate at which the nanopore 20 expands from its smallest dimension, d₂.

Comparative studies of water flux were also performed for two 5 μm long nanopores at 15 atmospheres. One nanopore was cylindrical with diameter of 10 nm and the other nanopore was conical and had 10 nm and 250 nm diameter openings. It was determined that the water flux through the conical pore was approximately 65 times higher than the flux through the cylindrical pore.

FIG. 8 is a graph that illustrates that a conical nanopore having zones of positive and negative surface charges as shown in FIG. 3 provided a higher salt rejection at lower concentrations of feed solution. The graph presents results of numerical modeling.

While the foregoing disclosure has identified dissolved salts as an exemplary undesired component of a liquid to be rejected, the systems, methods, and membranes can be generally used to reject ions contained in a feed solution. As described above, examples of such ions include inorganic ions, such as K⁺, Cl⁻, Na⁺, Li⁺, Cs⁺, Br, Ca²⁺, Mg²⁺, and HPO₄²⁻, and small organic ions, such as succinate and acetate. In addition, while water has been identified as an exemplary liquid to be purified, the disclosed systems, methods, and membranes are also applicable to the purification of other liquids, such as acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethylene glycol, diethyl ether, diglyme (diethylene glycol dimethyl ether), 1,2-dimethoxy-ethane (glyme, DME), dimethylformamide (DMF), dimethyl sulfoxide (DMSO), 1,4-dioxane, ethanol, ethyl acetate, ethylene glycol, glycerin, heptane, Hexamethylphosphoramide (HMPA), Hexamethylphosphorous, triamide (HMPT), hexane, methanol, methyl t-butyl, ether (MTBE), methylene chloride, N-methyl-2-pyrrolidinone (NMP), nitromethane, pentane, Petroleum ether (ligroine), 1-propanol, 2-propanol, pyridine, tetrahydrofuran (THF), toluene, triethyl amine, water, water, o-xylene, m-xylene, p-xylene, and combinations thereof.

### EXAMPLE

### Example 1

Experiments were performed to test asymmetric charged membranes of the type shown in FIG. 3. Membranes were fabricated using polymer films made of two materials: polyethylene terephthalate (PET) and polyimide (Kapton 50 HN). Nanopores were formed in films using a track-etching technique so that conical nanopores were obtained. A conical shape of the nanopores was achieved by performing the etching process asymmetrically so that one side of the membrane was in contact with the etchant (e.g., 9 M NaOH for PET and concentrated bleach for Kapton) and the other side was in contact with a stopping medium (e.g. acid solution). These membranes were not subjected to any additional chemical modification, thus their nanopores were negatively charged due to the presence of carboxyl groups.

In order to achieve a surface charge pattern similar to that shown in FIG. 3, a modification procedure was performed with amines. The modification utilizes carboxyl groups present on the majority of polymer nanopores after track-etching. Briefly, the modification entailed placing the membrane in contact with a solution of amines and a linking agent EDC ((1-ethyl-3-(3-dimethylaminopropyl) carbodiimide hydrochloride) on one side and a buffer solution on the other side. This procedure allows the formation of a sharp junction between a zone with positive surface charges due to amines and a zone with negative charges due to carboxyl groups. As liquid purification is predicted to be higher when the density of charges on the nanopore walls is higher, modification with molecules that contain multiple amine groups may be preferable. Preliminary results of salt rejection were obtained with nanopores modified with spermine, a molecule that when fully charged carries charge of four elementary charges. Another example of a molecule with multiple positive charges is poly(lysine) or other polyelectrolytes. Positive charges were introduced into the tip zone of the conical geometry.

It is noted that other chemistries can be used to impart positive surface charges to the nanopores, such as plasma modification or silanol-based chemistries for some inorganic materials. It is further noted that a similar approach can be used to enhance the density of negative surface charges. This can be accomplished through attachment of molecules containing one amine group and multiple carboxyl groups. Alternatively, the surface could first be aminated, followed by attachment of molecules with multiple negatively charged carboxyl groups (e.g., poly(glutamic acid)), one of which being used to create a peptide bond.

It is noted that the PET membranes did not rectify the current, possibly due to larger heterogeneity of the pore openings (caused by semicrystalline structure of the material) and a smaller opening angle compared to Kapton pores.

### Example 2

Experiments were also performed to test the effectiveness of 10 fabricated nanopore membranes in rejecting KCl from water. Eight of these membranes were polyimide (Kapton) membranes and two of the membranes were PET membranes. Some of the membranes were chemically modified in the manner described above in Example 1 to provide them with high-density surface charges, while other membranes were left unmodified. The modified Kapton membranes were modified using spermine, while the modified PET membranes were modified using diamine.

The experiments were performed in a pressurized conductivity cell. The results of the experiments are presented in Table 1. In Table 1, “diode” indicates that the membrane had a diode surface charge pattern comprising a zone with positive surface charges and a zone with negative surface charges. The unmodified Kapton membranes rejected salt (from 100 mM KCl) at the level of approximately 15%. The chemical modification of Kapton membranes improved the rejection levels to 30% and higher. The data for Membrane 3 show that higher salt rejection can be achieved from a solution with lower salt concentration (50% rejection from 100 mM, and 65% from 50 mM). Salt rejection was also observed for the two PET membranes. Membrane 9 was not chemically modified and, therefore, contained only negatively charged carboxylate groups. This membrane did not reject any salt. After modification with diamines, however, the same membrane rejected salt at the 32% level from 100 mM KCl.

TABLE 1
Salt Rejection of Sample Nanopore Membranes. The membranes were
characterized with a flux through a small circular membrane between
100 and 300 μL per minute and 0.8 cm² area, i.e., between 80 and 230
liters per hour per m².

| | | Salt rejection from KCl |
|---|---|---|
| | | solutions (KCl |
| | Surface charge on | concentration given in |
| Membrane | the pore walls | parentheses) |
| Membrane 1, Kapton, | diode | 35% (100 mM), 60 psi |
| 10⁸ per cm² | | |
| Membrane 2, Kapton, | diode | 41% (100 mM), 60 psi |
| 10⁸ per cm² | | |
| Membrane 3, Kapton, | diode | 50% (100 mM), 70 psi; |
| 2 10⁸ per cm² | | 65% (50 mM), 70 psi |
| Membrane 4, 10⁸ per | diode | 55% (100 mM), 60 psi |
| cm² | | |
| Membrane 5, Kapton, | unmodified, i.e. | 16% (100 mM), 60 psi |
| 10⁸ per cm² | negatively charged | |
| Membrane 6, Kapton, | unmodified, i.e. | 14% (100 mM), 60 psi |
| 2 [symbol] 10⁸ per cm² | negatively charged | |
| Membrane 7, Kapton, | unmodified, i.e. | 14% (100 mM), 60 psi |
| 2 [symbol] 10⁸ per cm² | negatively charged | |
| Membrane 8, 10⁸ per | unmodified, i.e. | 17% (100 mM), 60 psi |
| cm² | negatively charged | |
| Membrane 9, PET, | unmodified, i.e. | 0% (100 mM), 60 psi |
| 10⁸ per cm² | negatively charged | |
| | diode | 32% (100 mM), 60 psi |
| Membrane 10, PET, | diode | 42% (10 mM), 40 psi |
| 10⁸ per cm² | | |

Claimed are:

1. A membrane comprising:
a plurality of nanopores, each nanopore comprising a first opening, a second opening, and an inner surface that extends between the first and second openings, wherein at least one nanopore comprises a positive surface charge zone extending along a portion of a length of the nanopore and a negative surface charge zone extending along a different portion of the length of the nanopore, wherein the inner surface of the nanopore has high-density positive surface charges within the positive surface charge zone and high-density negative surface charges within the negative surface charge zone.

2. The membrane of claim 1, wherein the membrane has a nanopore density of approximately 10⁷ to 10¹¹ nanopores per square centimeter.

3. The membrane of claim 1, wherein the high-density surface charges have surface charge densities of approximately 0.03 to 0.4 C/m².

4. The membrane of claim 1, wherein the nanopores have non-constant cross-sections along their lengths.

5. The membrane of claim 4, wherein the nanopores are tapered.

6. The membrane of claim 4, wherein the nanopores are conical.

7. The membrane of claim 4, wherein the first opening is larger than the second opening.

8. The membrane of claim 7, wherein the first opening has a cross-sectional dimension of approximately 300 to 2,000 nm.

9. The membrane of claim 8, wherein the second opening has a cross-sectional dimension of approximately 1 to 15 nm.

10. The membrane of claim 9, wherein the nanopores are approximately 500 nm to 10 μm long.

11. The membrane of claim 9, wherein one of the surface charge zones is adjacent to the second opening and is approximately 10 nm to 100 μm long.

12. The membrane of claim 9, wherein the negative surface charge zone is adjacent to the first opening and the positive surface charge zone is adjacent to the second opening.

13. A liquid purification system comprising:
a membrane comprising a plurality of nanopores that extend through the membrane, each nanopore comprising a first opening, a second opening, and an inner surface that extends between the first and second openings, wherein at least one nanopore comprises a positive surface charge zone extending along a portion of a length of the nanopore and a negative surface charge zone extending along a different portion of the length of the nanopore, wherein the inner surface of the nanopore has high-density positive surface charges within the positive surface charge zone and high-density negative surface charges within the negative surface charge zone; and
means for driving a liquid to be purified through the membrane.

14. The system of claim 13, wherein the means for driving comprise a piston.

15. A method for purifying a liquid to remove undesired components from the liquid, the method comprising:
providing a membrane comprising a plurality of nanopores that extend through the membrane, each nanopore comprising a first opening, a second opening, and an inner surface that extends between the first and second openings, wherein at least one nanopore comprises a positive surface charge zone extending along a portion of a length of the nanopore and a negative surface charge zone extending along a different portion of the length of the nanopore, wherein the inner surface of the nanopore has high-density positive surface charges within the positive surface charge zone and high-density negative surface charges within the negative surface charge zone; and
pressurizing the liquid to drive it through the nanopores of the membrane, wherein the liquid has a lower concentration of the undesired components after the liquid has passed through the membrane.

16. The method of claim 15, wherein purifying a liquid to remove undesired components from the liquid comprises desalinating water to remove salt from the water.

17. The method of claim 15, wherein the high-density surface charges have surface charge densities of approximately 0.03 to 0.4 C/m².

18. The method of claim 15, wherein the nanopores have non-constant cross-sections along their lengths.

19. The method of claim 15, wherein pressurizing the liquid comprises increasing the pressure of the liquid to approximately 40 to 100 psi.

20. The method of claim 15, wherein the liquid passes through the membrane at a rate of approximately 40 to 80 liters/m² hr.
